(19) United States
(12) Patent Application Publication
(10) Pub. No.: US 2025/0179619 A1
(43) Pub. Date: Jun. 5, 2025

(54) NON-ORIENTED ELECTRICAL STEEL SHEET

(71) Applicant: NIPPON STEEL CORPORATION, Tokyo (JP)

(72) Inventors: Takeru ICHIE, Tokyo (JP); Kenichi MURAKAMI, Tokyo (JP); Fuminobu MURAKAMI, Tokyo (JP)

(73) Assignee: NIPPON STEEL CORPORATION, Tokyo (JP)

(21) Appl. No.: 18/729,135

(22) PCT Filed: Mar. 24, 2023
(86) PCT No.: PCT/JP2023/011703

§ 371 Date: Jul. 15, 2024

(30) Foreign Application Priority Data
Mar. 24, 2022 (JP) 2022-048997

(51) Int. Cl. C22C 38/60; C22C 38/02; C22C 38/04; C22C 38/06

(52) U.S. Cl. CPC C22C 38/60; C22C 38/02; C22C 38/04; C22C 38/06

(57) ABSTRACT

A non-oriented electrical steel sheet according to an aspect of the present invention includes a composition containing, in mass %, C: 0.0005 to 0.0030%, Si: 1.5 to 3.5%, Al: 0.10 to 2.00%, Mn: 0.1 to 2.0%, P: 0.180% or less, S: 0.0005 to 0.0030%, N: 0.0005 to 0.0030%, Ti: 0.0005 to 0.0030%, B: 0 to 0.0020%, and Sn+2×Sb: 0 to 0.25%; and the remainder being Fe and impurities, wherein 2≤A≤10, 1.0≤B≤10, and 0.8≤B/A≤1.0 are satisfied in which a sheet thickness is t, a strength of a {111}<112> orientation, a crystal orientation measured at a position in a range of 2/5 t to 3/5 t is A, and a strength of a {100}<012> orientation measured at the position in a range of 2/5 t to 3/5 t is B.

### TECHNICAL FIELD OF THE INVENTION

The present disclosure relates to a non-oriented electrical steel sheet.

The present application claims priority based on Japanese Patent Application No. 2022-048997 filed in Japan on Mar. 24, 2022, the contents of which are incorporated herein by reference.

### RELATED ΔRT

In the field of motors, particularly in the field of electrical equipment such as compressors, medium-to-small transformers, and electrical components of air conditioners and refrigerators, there is an increasing demand for higher efficiency and miniaturization of electrical equipment in a global environmental conservation movement represented by power reduction, energy saving, reduction in CO₂ emission, and the like. For this purpose, it is necessary to achieve high performance of a non-oriented electrical steel sheet used as a motor core.

Further, also in the field of automobiles, a non-oriented electrical steel sheet is used as a core for a drive motor of a hybrid drive vehicle or an electric vehicle. Since domestic and foreign automobile manufacturers publicly declare an increase in production of the above electric drive vehicles, a demand for a non-oriented electrical steel sheets to be used is greatly increasing. In such a background, improvement of magnetic characteristics of a non-oriented electrical steel sheet used as a core material of a motor and mass production thereof are supreme propositions.

As described above, in the non-oriented electrical steel sheet, it is necessary to achieve both high performance and mass production. Among these propositions, for example, Patent Document 1 and Patent Document 4 describe a method for improving a magnetic flux density of a product sheet by performing hot-band annealing after a hot rolling step and controlling hot-band annealing conditions at that time, particularly in achieving high performance.

However, it has been found that, in the method for controlling hot-band annealing conditions, the difference between the magnetic flux density in a rolling direction and the magnetic flux density in an orthogonal-to-rolling direction of a product sheet becomes large. In such a case, when a motor is rotated, a magnetic flux changes depending on a rotational position, thereby generating a torque called cogging torque, and as a result, smoothness of rotation is lost. For this reason, there is a need for a non-oriented electrical steel sheet in which magnetic flux density for each angle with respect to a rolling direction of a product sheet (that is, anisotropy of magnetic characteristics) is small. In addition, when further mass production is performed in the future, a hot-band annealing step may be a neck step. In that case, mass production may have been greatly restricted.

In such a background, Patent Document 1 and Patent Document 2 propose a method for omitting a hot-band annealing step by setting a finishing hot rolling temperature to 800° C. or lower. Patent Document 3 proposes a method for omitting a hot-band annealing step by setting a finishing hot rolling temperature to 700° C. to 950° C. and setting a coiling temperature to 750° C. or lower. However, in these methods, it is necessary to increase a rolling load. Therefore, in these methods, it is not easy to make a predetermined sheet thickness, and these methods are not appropriate for application to an actual machine.

### CITATION LIST

### Patent Document

Patent Document 1: Japanese Unexamined Patent Application, First Publication No. 2010-1557
Patent Document 2: Japanese Unexamined Patent Application, First Publication No. 2011-111658
Patent Document 3: Japanese Unexamined Patent Application, First Publication No. 2018-178197
Patent Document 4: Japanese Unexamined Patent Application, First Publication No. 2004-197217

### SUMMARY OF INVENTION

### Problems to be Solved by the Invention

In the related art, a difference in magnetic flux density for each angle of a non-oriented electrical steel sheet, that is, a magnetic flux density deviation is large, and further mass production of a non-oriented electrical steel sheet may have been greatly restricted.

Patent Document 3 discloses a non-oriented electrical steel sheet in which a development degree I(s) of a {111}<112> orientation at a depth position of t/10 from a rolled surface is 6.0 or more, and a development degree I(c) of a {100}<012> orientation at a depth position of t/2 from the rolled surface is 4.0 or more. However, in the art disclosed in Patent Document 3, an object of controlling a development degree of a texture is to suppress occurrence of shear droop during punching of a non-oriented electrical steel sheet. Therefore, the development degree I(s) of the {111}<112> orientation is defined in a surface layer area of the steel sheet. In order to reduce the magnetic flux density deviation for each angle of a non-oriented electrical steel sheet, it is necessary to control a development degree of a texture at a thickness middle portion of the steel sheet. However, Patent Document 3 does not define the development degree of the {111}<112> orientation at the thickness middle portion, and also does not disclose a method for controlling the development degree.

Patent Document 4 discloses a non-oriented electrical steel sheet in which whole circumference magnetic characteristics are improved using a hot-band annealing step. Furthermore, the art disclosed in Patent Document 4 considers that a {111} texture is unfavorable for magnetic characteristics of a non-oriented electrical steel sheet, and suppresses the development thereof. However, the hot-band annealing step reduces productivity of a non-oriented electrical steel sheet. Therefore, reduction of the magnetic flux density deviation for each angle by a method different from hot-band annealing is required.

In view of the above demand, a problem of the present disclosure is to eliminate a large restriction on further mass production of a non-oriented electrical steel sheet in addition to reducing a magnetic flux density deviation for each angle of the non-oriented electrical steel sheet, and an object of the present disclosure is to provide a non-oriented electrical steel sheet having good characteristics for each angle and productivity for solving the problem.

### Means for Solving the Problem

The gist of the present disclosure is as follows.
(1) A non-oriented electrical steel sheet according to an aspect of the present invention includes a composition containing, in mass %, C: 0.0005 to 0.0030%, Si: 1.5 to 3.5%, Al: 0.10 to 2.00%, Mn: 0.1 to 2.0%, P: 0.180% or less, S: 0.0005 to 0.0030%, N: 0.0005 to 0.0030%, Ti: 0.0005 to 0.0030%, B: 0 to 0.0020%, and Sn+2×Sb: 0 to 0.25%; and the remainder being Fe and impurities, wherein the following Formulas (i) to (iii) are satisfied, in which a sheet thickness is t, a strength of a {111}<112> orientation, a crystal orientation measured at a position in a range of 2/5 t to 3/5 t is A, and a strength of a {100}<012> orientation measured at the position in a range of 2/5 t to 3/5 t is B,

$$2 \leq A \leq 10 , \qquad Formula ( i )$$

$$1. \leq B \leq 10 , and \qquad Formula ( ii )$$

$$0.8 \leq B / A \leq 1. . \qquad Formula ( iii )$$

(2) Preferably, in the non-oriented electrical steel sheet according to (1), the composition contains, in mass %, Sn or Sb in a range of 0.02≤Sn+2×Sb≤0.20.

### Effects of the Invention

According to the present disclosure, it is possible to provide a non-oriented electrical steel sheet that has a small magnetic flux density deviation for each angle, has excellent magnetic characteristics, and further has excellent productivity for a motor core.

### BRIEF DESCRIPTION OF THE DRAWINGS

FIG. 1 A graph showing the relationship between {111}<112> orientation strength A at a thickness middle portion and B50/Bs.

FIG. 2 A graph showing the relationship between {100}<012> orientation strength B at a thickness middle portion and B50/Bs.

FIG. 3 A graph showing the relationship between proportion B/A of {100}<012> orientation strength B to {111}<112> orientation strength A at a thickness middle portion and B50/Bs.

FIG. 4 A graph showing the relationship between proportion B/A and a ΔB50 value, which is a difference between an absolute maximum value and an absolute minimum value in B50 measurement values in a rolling direction, an orthogonal-to-rolling direction, and a direction at 45 degrees from the rolling direction.

FIG. 5 A graph showing the proportion of areas in a recrystallized structure and a worked structure of a hot band (recrystallized area/worked structure area) and proportion B/A.

FIG. 6 A cross-sectional view showing a position in a range of 2/5 t to 3/5 t of a non-oriented electrical steel sheet.

FIG. 7 A perspective view showing a center portion in a width direction of a coiled hot band.

### EMBODIMENT OF THE INVENTION

In order to solve the above problem, the present inventors have intensively studied a texture in steel and step conditions such as hot rolling conditions. As a result, the present inventors have found that it is possible to decrease a magnetic flux density deviation for each angle of a product sheet by omitting hot-band annealing and actively controlling a hot rolling step, and it is possible to manufacture a non-oriented electrical steel sheet with less restriction on mass production due to no hot-band annealing.

The present disclosure is based on the above finding. A non-oriented electrical steel sheet according to an aspect of the present invention is as follows.

The non-oriented electrical steel sheet according to an aspect of the present invention is a non-oriented electrical steel sheet including a composition containing, in mass %, C: 0.0005 to 0.0030%, Si: 1.5 to 3.5%, Al: 0.10 to 2.00%, Mn: 0.1 to 2.0%, P: 0.180% or less, S: 0.0005 to 0.0030%, N: 0.0005 to 0.0030%, Ti: 0.0005 to 0.0030%, B: 0 to 0.0020%, and Sn+2×Sb: 0 to 0.25%; and the remainder being Fe and impurities, wherein when the sheet thickness is t, the strength of a {111}<112> orientation, the crystal orientation measured at a position in a range of 2/5 t to 3/5 t is A, and the strength of a {100}<012> orientation measured at the position in a range of 2/5 t to 3/5 t is B, the following Formulas (1) to (3) are satisfied.

$$2 \leq A \leq 10 \qquad Formula ( 1 )$$

$$1. \leq B \leq 10 \qquad Formula ( 2 )$$

$$0.8 \leq B / A \leq 1. \qquad Formula ( 3 )$$

The composition of the non-oriented electrical steel sheet may contain, in mass %, Sn or Sb in a range of 0.02≤Sn+2×Sb≤0.20.

Next, the non-oriented electrical steel sheet according to the present embodiment and a manufacturing method thereof will be described.

### <Electrical Steel Sheet>

The non-oriented electrical steel sheet according to the present embodiment allows a recrystallized structure and a worked structure of a steel sheet before cold rolling to coexist in a well-balanced manner, and controls a specific orientation strength in a product sheet within a predetermined range, thereby achieving both an increase in the magnetic flux density and a decrease in a magnetic flux density deviation for each angle.

In order to increase the magnetic flux density of the electrical steel sheet, it is necessary to increase a {100}<012> orientation strength measured at a thickness middle portion, but the magnetic flux density deviation for each angle increases. On the other hand, when a {111}<112> orientation strength is increased contrary to the {100}<012> orientation measured at the thickness middle portion, the magnetic flux density for each angle tends to decrease. That is, in order to increase the magnetic flux density and decrease the magnetic flux density deviation for each angle, it is important to balance development degrees of both the {100}<012> orientation and the {111}<112> orientation measured at the thickness middle portion.

The thickness middle portion is a position in a range of 2/5 t to 3/5 t. t is a sheet thickness of the non-oriented electrical steel sheet. The thickness middle portion A of the non-oriented electrical steel sheet 1 is shown in a cross-sectional view of FIG. 6.

Usually, hot-band annealing is performed by continuous annealing. Therefore, a metallographic structure of an electrical steel sheet before cold rolling is a recrystallized structure in which no worked structure exists. After a steel sheet having such a microstructure is subjected to cold rolling and annealing, the {100}<012> orientation appears from within grains, and the magnetic flux density is increased. However, in the electrical steel sheet obtained by this manufacturing method, the magnetic flux density deviation is large.

On the other hand, when hot-band annealing is not performed, the metallographic structure of an electrical steel sheet before cold rolling has a partially recrystallized structure, but has many worked structures. After cold rolling and annealing of the steel sheet, the {111}<112> orientation appears from the worked structure. In the electrical steel sheet thus obtained, the magnetic flux density has been low. Also in the related art, a {111} texture has been considered to be unfavorable for magnetic characteristics of a non-oriented electrical steel sheet. However, the present inventors have found that the magnetic flux density deviation decreases in a non-oriented electrical steel sheet in which the {111}<112> orientation appears. Therefore, the present inventors have further studied a method for increasing the magnetic flux density while reducing the magnetic flux density deviation using the {111}<112> orientation.

So far, the present inventors have studied to lower a hot-band annealing temperature and to achieve both a recrystallized structure and a worked structure in a steel sheet before cold rolling. The area fraction of both microstructures is desirably in a range of 4:1 to 5:1. However, since hot-band annealing is performed at a high temperature in a short time, a range of a target temperature and an annealing time for achieving such a microstructure area fraction is narrow. Therefore, the operation has been difficult.

The present inventors coiled a steel sheet after finishing hot rolling at a high temperature and then held the steel sheet for a long time to allow a recrystallized structure and a worked structure of the steel sheet before cold rolling to coexist in a well-balanced manner. As a result, the {111}<112> orientation strength and the {100}<012> orientation strength at a thickness middle portion of a product sheet are controlled within predetermined ranges, thereby achieving both an increase in the magnetic flux density and a decrease in the magnetic flux density deviation for each angle.

### [Composition]

Next, a reason for limiting a composition of the non-oriented electrical steel sheet according to the present embodiment will be described. Note that “%” related to the composition means “mass %”.

### C: 0.0005 to 0.0030%

Since C is an element that causes magnetic aging and increases iron loss, C is set to 0.0030% or less. C is preferably 0.0025% or less, and more preferably 0.0020% or less. On the other hand, when C is less than 0.0005%, iron loss is not reduced, and thus the lower limit of C is set to 0.0005%. C is preferably 0.0008% or more, 0.0010% or more, or 0.0015% or more.

### Si: 1.5 to 3.5%

Si is an element that inhibits magnetic flux density, increases hardness, inhibits workability such as cold rolling in a manufacturing step of a steel sheet, increases manufacturing cost, and inhibits punching workability. On the other hand, Si is an element that increases electric resistance of a steel sheet, reduces eddy-current loss, and reduces iron loss.

When Si exceeds 3.5%, magnetic flux density and punching workability are significantly reduced, and manufacturing cost is increased, and thus Si is set to 3.5% or less. Si is preferably 3.3% or less, and more preferably 3.2% or less. On the other hand, when Si is less than 1.5%, electric resistance of the steel sheet does not increase and iron loss does not decrease, and thus Si is set to 1.5% or more. Si is preferably 1.8% or more, and more preferably 2.0% or more.

### Al: 0.10 to 2.00%

Al is an element that is mixed into a steel sheet from an ore to be a material of steel or a refractory used in a steel casting facility, contributes to deoxidation, and acts to increase electric resistance to reduce eddy-current loss and reduce iron loss similarly to Si.

When Al is less than 0.10%, fine AlN is formed to adversely affect iron loss, and thus Al is set to 0.10% or more. Al is preferably 0.20% or more, and more preferably 0.50% or more.

On the other hand, when Al exceeds 2.00%, saturation magnetic flux density decreases and magnetic flux density decreases, and thus Al is set to 2.00% or less. Al is preferably 1.50% or less, and more preferably 1.20% or less.

### Mn: 0.1 to 2.0%

Mn is an element that increases electric resistance, reduces eddy-current loss, and suppresses precipitation of fine sulfides such as MnS, which is harmful to growth of grains.

When Mn is less than 0.1%, the above-described effect cannot be sufficiently obtained, and thus Mn is set to 0.1% or more. Mn is preferably 0.2% or more, and more preferably 0.4% or more. On the other hand, when Mn exceeds 2.0%, growth of grains during annealing decreases, and iron loss increases, and thus Mn is set to 2.0% or less. Mn is preferably 1.5% or less, and more preferably 1.2% or less.

P: 0.180% or less

When P exceeds 0.180%, toughness is reduced and the steel sheet is likely to be fractured, and thus P is set to 0.180% or less. P is preferably 0.150% or less, and more preferably 0.120% or less. The lower limit of P is not particularly limited, and may be 0%, but 0.001% is a substantial lower limit in consideration of manufacturing cost. P may be 0.002% or more, 0.005% or more, or 0.010% or more.

### S: 0.0005 to 0.0030%

S is an element that forms fine sulfides such as MnS and inhibits recrystallization and grain growth during final annealing or the like. When S exceeds 0.0030%, recrystallization and grain growth during final annealing or the like are significantly inhibited, and thus S is set to 0.0030% or less. S is preferably 0.0020% or less, and more preferably 0.0015% or less.

The lower limit of S is not particularly limited in terms of securing magnetic characteristics of the non-oriented electrical steel sheet, but 0.0005% is the lower limit in consideration of industrial purification technology, and 0.0008% is a substantial lower limit in consideration of manufacturing cost.

### N: 0.0005 to 0.0030%

N is an element that forms precipitates and increases iron loss. When N exceeds 0.0030%, iron loss significantly increases, and thus N is set to 0.0030% or less. N is preferably 0.0020% or less, and more preferably 0.0015% or less. The lower limit of N is not particularly limited, but 0.0005% is a substantial lower limit in consideration of manufacturing cost. N may be 0.0008% or more, 0.0010% or more, or 0.0012% or more.

### Ti: 0.0005 to 0.0030%

Ti is an element that forms precipitates and increases iron loss. When Ti exceeds 0.0030%, iron loss significantly increases, and thus Ti is set to 0.0030% or less. Ti is preferably 0.0020% or less, and more preferably 0.0015% or less. The lower limit of Ti is not particularly limited, but 0.0005% is a substantial lower limit in consideration of manufacturing cost. Ti may be 0.0008% or more, 0.0010% or more, or 0.0012% or more.

### B: 0 to 0.0020%

B is an element that forms precipitates and increases iron loss. When B exceeds 0.0020%, iron loss significantly increases, and thus B is set to 0.0020% or less. B is preferably 0.0010% or less, and more preferably 0.0005% or less. The lower limit of B is not particularly limited, and may be, for example, 0%, but may be, for example, 0.0001%.

In the non-oriented electrical steel sheet according to the present embodiment, one or two of Sn and Sb may be contained in a range of 0.02≤Sn+2×Sb≤0.25. Sn and Sb are elements that suppress surface nitriding and also contribute to reduction of iron loss. This effect can be obtained when Sn+2×Sb is 0.02% or more. Therefore, the lower limit of Sn+2×Sb is preferably 0.02%. However, the non-oriented electrical steel sheet according to the present embodiment can solve the problem without containing Sn and Sb. Therefore, the lower limit of Sn+2×Sb may be 0%.

On the other hand, when Sn+2×Sb exceeds 0.25%, toughness of the steel sheet is deteriorated. Therefore, the upper limit of Sn+2×Sb is preferably 0.25%. A better range of Sn+2×Sb is a lower limit of 0.05% or a lower limit of 0.08. A better range of Sn+2×Sb is an upper limit of 0.20%, an upper limit of 0.15%, or an upper limit of 0.10%.

It is not necessary to independently define the amounts of Sn and Sb, but preferred amounts of Sn and Sb are exemplified below. The Sn content is, for example, preferably 0% or more, 0.02% or more, 0.05% or more, or 0.10% or more. The Sn content is, for example, preferably 0.25% or less, 0.20% or less, 0.18% or less, 0.15% or less, or 0.12% or less. The Sb content is, for example, preferably 0% or more, 0.01% or more, 0.02% or more, or 0.05% or more. The Sn content is, for example, preferably 0.15% or less, 0.10% or less, 0.09% or less, 0.08% or less, or 0.06% or less.

### Remainder: Fe and Impurities

In the non-oriented electrical steel sheet according to the present embodiment, a remainder excluding the above elements is Fe and impurities. The impurity is an element that is mixed into the electrical steel sheet from a steel raw material and/or in a steelmaking process and is allowed as long as characteristics of the non-oriented electrical steel sheet according to the present embodiment are not impaired.

For example, Cu or Ni may be contained in the electrical steel sheet as long as it does not exceed 0.1%. The electrical steel sheet may also contain other elements in a range not exceeding 0.05%.

### [Texture]

The reason why numerical values of strengths of the texture {111}<112> orientation and the {100}<012> orientation in the non-oriented electrical steel sheet according to the present embodiment are limited will be described below. In the non-oriented electrical steel sheet according to the present embodiment, the strengths of the {111}<112> orientation and the {100}<012> orientation measured at a position in a range of 2/5 t to 3/5 t (that is, thickness middle portion) are limited. The state of the texture is different between a surface layer area in which the temperature rising rate and the temperature falling rate are high during heat treatment and a central part in which the temperature rising rate and the temperature falling rate are low during heat treatment. In addition, it is the texture at the central part of the sheet thickness that strongly affects magnetic characteristics of the non-oriented electrical steel sheet.

When the {111}<112> orientation strength and the {100}<012> orientation strength of the non-oriented electrical steel sheet measured at the position in a range of 2/5 t to 3/5 t are A and B, respectively, these values need to satisfy Formulas (1) to (3).

$$2 \leq A \leq 10 \qquad Formula ( 1 )$$

$$1. \leq B \leq 10 \qquad Formula ( 2 )$$

$$0.8 \leq B / A \leq 1. \qquad Formula ( 3 )$$

The texture is observed by observing a surface parallel to the sheet surface at the thickness middle portion. When the sheet thickness of the non-oriented electrical steel sheet is t, the observation site is the position in a range of 2/5 t to 3/5 t. That is, as shown in FIG. 6 (cross-sectional view of the non-oriented electrical steel sheet 1), the observation site is a region A between a position at a depth of 2/5 t from one surface of the non-oriented electrical steel sheet 1 and a position at a depth of 3/5 t from the surface. After the surface of the thickness middle portion is exposed by polishing, chemical etching is performed, and the texture of the observed section is observed by XRD. As described above, since the state of the texture is different between the surface layer area and the thickness middle portion of the non-oriented electrical steel sheet, the measurement result of the orientation strength is affected by the depth of the measured region.

In addition, as an example of magnetic measurement, a sample having a size of 55 mm square was sheared from a product sheet, and B50 in a rolling direction, an orthogonal-to-rolling direction, and a direction 45 degrees from the rolling direction was measured by a single sheet tester method (SST method). B50 in a rolling direction, an orthogonal-to-rolling direction, and a direction 45 degrees from the rolling direction is a measurement value along each direction of a magnetic flux density of a test piece when the test piece is excited in a magnetic field of 5000 A/m. The difference between the absolute maximum value and the absolute minimum value in a B50 measurement value in the rolling direction, a B50 measurement value in the orthogonal-to-rolling direction, and a B50 measurement value in the direction 45 degrees from the rolling direction is defined as a ΔB50 value.

The non-oriented electrical steel sheet according to the present embodiment is characterized by controlling orientation strength A and orientation strength B measured at the thickness middle portion so as to satisfy Formulas (1) to (3), thereby achieving both an increase in the magnetic flux density and a decrease in the magnetic flux density deviation for each angle.

Furthermore, it is preferable that a proportion of a ΔB50 value, which is a difference between an absolute maximum value and an absolute minimum value in a B50 measurement value in the rolling direction, a B50 measurement value in the orthogonal-to-rolling direction, and a B50 measurement value in the direction 45 degrees from the rolling direction, to a saturation magnetic flux density Bs satisfies the following Formula (4).

$$Δ B 50 / Bs \leq 0.05 \qquad Formula ( 4 )$$

### ({111}<112> Orientation Strength A Measured at Thickness Middle Portion: 2≤A≤10)

When {111}<112> orientation strength A measured at the thickness middle portion is less than 2, it is necessary to increase a coiling temperature in order to coarsen a grain size of a hot band before cold rolling, and an internal oxide layer is generated in the hot band due to the influence, which affects appearance of a product sheet. Therefore, {111}<112> orientation strength A measured at the thickness middle portion is 2 or more, preferably 3 or more, 4 or more, or 5 or more.

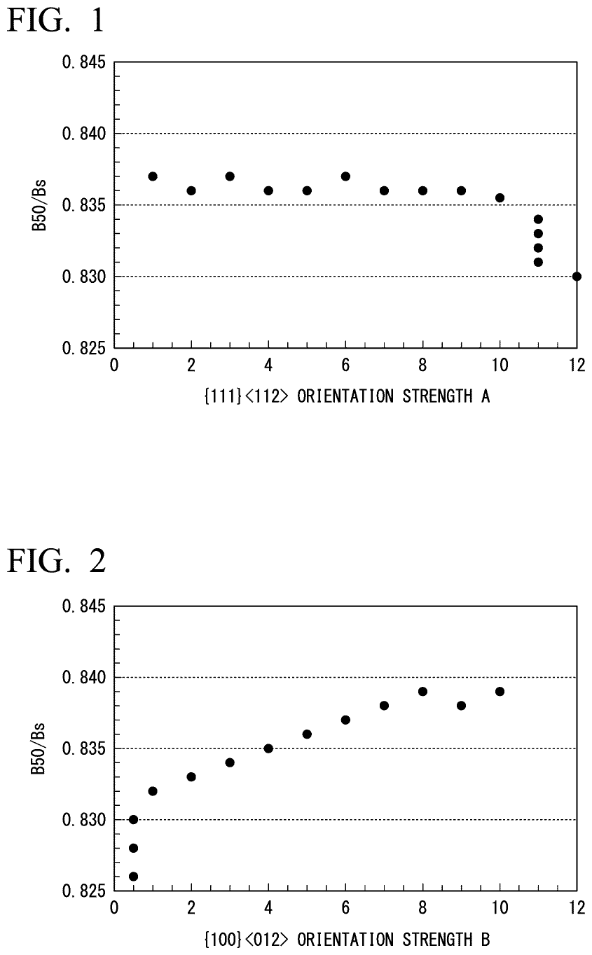

In addition, when {111}<112> orientation strength A measured at the thickness middle portion exceeds 10, this orientation itself is an orientation that is difficult to be magnetized, and thus, as shown in FIG. 1, proportion B50/Bs of the magnetic flux density B50 to the saturation magnetic flux density Bs determined by a component value significantly decreases. Therefore, {111}<112> orientation strength A measured at the thickness middle portion is 10 or less, preferably 9 or less, 8 or less, or 7 or less. The value of the magnetic flux density B50 when the measurement direction is not specified is an average value of the B50 measurement value in the rolling direction and the B50 measurement value in the orthogonal-to-rolling direction.

### ({100}<012> Orientation Strength B Measured at Thickness Middle Portion: 1.0≤B≤10)

When {100}<012> orientation strength B measured at the thickness middle portion is less than 1.0, as shown in FIG. 2, proportion B50/Bs of the magnetic flux density B50 to the saturation magnetic flux density Bs determined by a component value significantly decreases.

In addition, when {100}<012> orientation strength B measured at the thickness middle portion exceeds 10, it is necessary to increase a coiling temperature in order to coarsen a grain size of a hot band before cold rolling, and an internal oxide layer is generated in the hot band due to the influence, which affects appearance of a product sheet. Therefore, {100}<012> orientation strength B measured at the thickness middle portion is 1.0 or more and 10 or less. {100}<012> Orientation strength B measured at the thickness middle portion is preferably 2.0 or more, 3.0 or more, or 5.0 or more. {100}<012> Orientation strength B measured at the thickness middle portion is preferably 9 or less, 8 or less, or 7 or less.

### (Proportion B/A of {100}<012> Orientation Strength B Measured at Thickness Middle Portion to {111}<112> Orientation Strength A Measured at Thickness Middle Portion: 0.8≤B/A≤1.0)

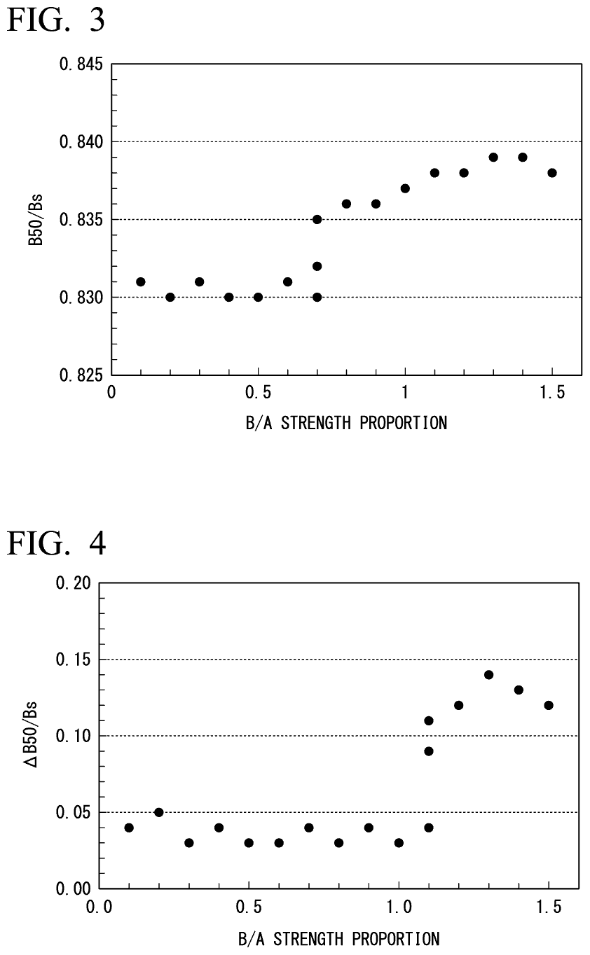

When the proportion B/A of {100}<012> orientation strength B measured at the thickness middle portion to {111}<112> orientation strength A measured at the thickness middle portion is less than 0.8, as shown in FIG. 3, proportion B50/Bs of the magnetic flux density B50 to the saturation magnetic flux density Bs determined by a component value significantly decreases. This is because the {111}<112> orientation is an orientation that deteriorates B50 with respect to a whole circumferential direction. Therefore, B/A is 0.8 or more, preferably 0.82 or more, 0.85 or more, or 0.90 or more.

On the other hand, when proportion B/A of {100}<012> orientation strength B measured at the thickness middle portion to {111}<112> orientation strength A measured at the thickness middle portion exceeds 1.0, ΔB50/Bs significantly increases. This is because the {100}<012> orientation is an orientation that improves characteristics of B50 in a 45° direction, and affects ΔB50/Bs as shown in FIG. 4. Therefore, B/A is 1.0 or less, preferably 0.98 or less, 0.95 or less, or 0.92 or less.

In general, it is considered that the {110}<001> orientation strength also affects magnetic characteristics of the non-oriented electrical steel sheet. However, in the non-oriented electrical steel sheet according to the present embodiment, since the {111}<112> orientation strength and the {100}<012> orientation strength are controlled as described above, the magnetic flux density can be increased and the magnetic flux density deviation for each angle can be decreased without controlling the {110}<001> orientation strength and the like.

### [Magnetic Characteristics Deviation]

When ΔB50/Bs is 0.05 or less, smoothness of a cogging torque in a motor can be significantly improved. Therefore, ΔB50/Bs is preferably 0.05 or less. ΔB50/Bs is more preferably 0.04 or less.

In order to increase the magnetic flux density, it is necessary to increase the {100}<012> orientation measured at the thickness middle portion. However, when the {100}<012> orientation is increased, a difference between a magnetic flux density in the rolling direction, a magnetic flux density in the orthogonal-to-rolling direction, and a magnetic flux density in the direction of 45 degrees from the rolling direction becomes large. On the other hand, the {111}<112> orientation tends to be opposite to the {100}<012> orientation. That is, in order to increase the magnetic flux density and decrease the magnetic flux density deviation for each angle, it is important to balance development degrees of both the {100}<012> orientation measured at the thickness middle portion and the {111}<112> orientation measured at the thickness middle portion.

### <Method for Manufacturing Non-Oriented Electrical Steel Sheet According to Present Embodiment>

The method for manufacturing the non-oriented electrical steel sheet according to the present embodiment is not particularly defined, but a preferred example is as follows.

A preferred example of the method for manufacturing the non-oriented electrical steel sheet according to the present embodiment includes:
a step of heating a slab;
a step of hot rolling the slab to obtain a hot band;
a step of coiling the hot band; and
a step of subjecting the steel sheet after cold rolling to finish annealing,
wherein a slab heating temperature is 1050 to 1250° C.,
a steel sheet surface temperature during passing through a final stand of finish rolling in the hot rolling is 800 to 1000° C.,
before the finish rolling of the hot rolling, the steel sheet surface temperature is made lower than a temperature of a central layer of the steel sheet by 50° C. or more,
a coil surface temperature during coiling is 650 to 900° C.,
a surface temperature at a center portion in a width direction of the hot band when 10 minutes elapse from immediately after the coiling is 550° C. or higher,
parameter PT1 calculated by substituting the steel sheet surface temperature during coiling and the steel sheet surface temperature after 10 minutes of coiling into Formula (5) is 17700 or more and 21500 or less,
a cold rolling ratio in the cold rolling is 75 to 90%,
a soaking temperature in the finish annealing is 950 to 1100° C., and
a soaking time in the finish annealing is 10 to 180 seconds.

$$PT 1 = ( ( TWC + CT ) / 2 + 273 ) \times ( 20 + Log ( 10 / 60 ) ) \qquad Formula ( 5 )$$

$$PT 2 = ( TA + 273 ) \times ( 20 + Log ( HA / 60 ) ) \qquad Formula ( 6 )$$

where:
TWC: steel sheet surface temperature at center portion of sheet width after 10 minutes of coiling, in unit ° C.,
CT: steel sheet surface temperature during coiling, in unit ° C.,
TA: soaking average temperature after coiling, and
HA: soaking time after coiling, in unit minute.

First, a slab is subjected to hot rolling. The chemical composition of the slab is the same as the chemical composition of the non-oriented electrical steel sheet according to the present embodiment described above. The slab heating temperature in the hot rolling is preferably 1050 to 1250° C. The slab heating temperature is a slab surface temperature when the slab is heated over a sufficient time to make the surface temperature and the center temperature of the slab substantially the same. When the slab heating temperature is lower than 1050° C., the coiling temperature of the steel sheet after hot rolling cannot be secured to a certain temperature or higher, resulting in deterioration of magnetic characteristics of a product sheet. When the slab heating temperature exceeds 1250° C., precipitates excessively form a solid solution and are finely precipitated during hot rolling, thereby deteriorating iron loss of a product sheet. A better range for the slab heating temperature is 1100 to 1200° C.

The steel sheet surface temperature during passing through a final stand of finish rolling in the hot rolling is preferably 800 to 1000° C. This is because when the sheet surface is out of this temperature range, a necessary coiling temperature range of a hot-rolled coil cannot be secured. A preferred temperature range of the sheet surface is 900 to 1000° C.

Furthermore, the temperature of the sheet surface is controlled to be lower than the temperature of the central layer by 50° C. or more by stopping the steel sheet before finish rolling to cool the steel sheet with air or by spraying air onto the steel sheet. As a result, the rolling resistance of the sheet surface is higher than that of the center. Therefore, strain introduced by rolling, which is a driving force of recrystallization, becomes non-uniform in a sheet thickness direction.

A combination of these hot rolling conditions makes it possible to mix a region that is easily recrystallized and a region that is not easily recrystallized, and as a result, it is possible to mix a recrystallized structure and a worked structure in the hot band.

Manufacturing conditions for making the surface of the steel sheet before finish rolling lower than the central layer by 50° C. or more can be determined by embedding thermocouples in the surface layer and the central layer of a hot band of the same size as an actual machine material in an offline test and establishing cooling conditions under which a temperature difference between the surface and the central layer is 50° C. or more. It can be estimated that a hot band manufactured under actual machine conditions defined based on these conditions has been finish-rolled in a state where the surface of the steel sheet before finish rolling is lower than the central layer by 50° C. or more.

The sheet thickness of the hot band is preferably 1.6 to 2.8 mm because if the sheet thickness is too large, magnetic characteristics of a product sheet are deteriorated, and if the sheet thickness is too thin, a required temperature cannot be secured. A more preferred sheet thickness range of the hot band is 1.8 to 2.5 mm.

The non-oriented electrical steel sheet according to the present embodiment can be manufactured without using annealing performed after hot rolling and before cold rolling, that is, hot-band annealing. However, in a suitable example of the method for manufacturing the non-oriented electrical steel sheet according to the present embodiment, soaking treatment is performed instead of hot-band annealing. The soaking treatment can be performed by controlling a surface temperature of a coil.

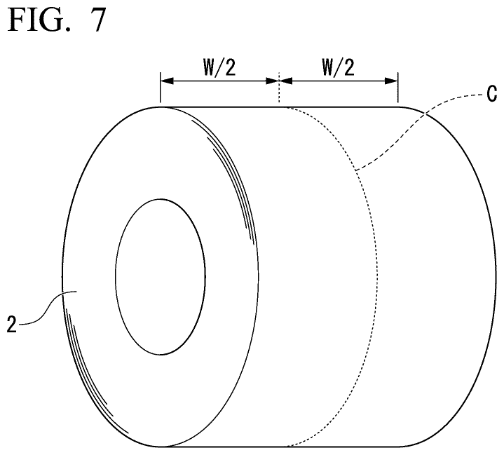

The coil surface temperature during coiling in hot rolling is preferably in a range of 650 to 900° C. The coil surface temperature is an outer surface temperature of a cylindrical coil 2 formed by coiling a hot band. The coil surface temperature is measured at a center portion C in a width direction of the coiled hot band (see FIG. 7). Note that a reference symbol W/2 described in FIG. 7 means a half value of a width W of the coil 2. The coil surface temperature is more preferably 700 to 850° C., and still more preferably 700 to 800° C.

When the coil surface temperature during coiling is lower than 650° C., the grain size of the hot band becomes small and the number of worked structures increases, so that the magnetic flux density becomes low. In addition, when the coil surface temperature during coiling exceeds 900° C., the grains of the hot band become large and toughness is deteriorated, so that the hot band may be fractured by pickling in the next step. Therefore, the coil surface temperature during coiling is preferably in a range of 650 to 900° C.

In addition, the steel sheet surface temperature (that is, coil surface temperature) at the center portion in the width direction of the coiled hot band is preferably 550° C. or higher, and more preferably 600° C. or higher when 10 minutes elapse from immediately after the coiling.

Furthermore, from the viewpoint of progress of recrystallization, parameter PT1 calculated by substituting the coil surface temperature during coiling and the coil surface temperature after 10 minutes of coiling into Formula (5) is preferably 17700 or more, and parameter PT2 represented by Formula (6) calculated from the soaking time and the soaking average temperature after coiling is more preferably 20000 or more.

$$PT 1 = ( ( TWC + CT ) / 2 + 273 ) \times ( 20 + Log ( 10 / 60 ) ) \qquad Formula ( 5 )$$

$$PT 2 = ( TA + 273 ) \times ( 20 + Log ( HA / 60 ) ) \qquad Formula ( 6 )$$

where:
TWC: steel sheet surface temperature (that is, coil surface temperature) at center portion of sheet width after 10 minutes of coiling, in unit ° C.,
CT: coil surface temperature during coiling, in unit° C.,
TA: soaking average temperature after coiling, and
HA: soaking time after coiling, in unit minute. The “soaking average temperature” represents a value obtained by dividing a difference between a coil surface temperature at a start time point and a coil surface temperature at an end time point of soaking by the soaking time. The start time point of soaking is a time point when coiling of the hot band is completed. The end time point of soaking is a time point when the coil surface temperature decreases by 10° C. from the temperature when coiling is completed. “Log” represents a logarithm with a base of 10.

A proportion of a recrystallized structure to a worked structure before cold rolling of a hot band obtained by this manufacturing method is in a range of 5:1 to 4:1. In a non-oriented electrical steel sheet obtained by subjecting the hot band to cold rolling and finish annealing, it is possible to increase the magnetic flux density and decrease the magnetic flux density deviation for each angle.

The reason why the proportion of a recrystallized structure to a worked structure of a hot band before cold rolling is controlled between 5:1 and 4:1 is as follows. The {111}<112> orientation is generated by cold rolling and annealing from a worked structure of a hot band before cold rolling, and the {100}<012> orientation is generated by cold rolling and annealing from a recrystallized structure of the hot band before cold rolling. When the proportion of a recrystallized structure to a worked structure of a hot band before cold rolling is 5:1 to 4:1, a proportion of the {100}<012> orientation strength B to the {111}<112> orientation strength A becomes 0.8≤B/A≤1.0 through cold rolling and annealing, and a non-oriented electrical steel sheet in which ΔB50/Bs is small and B50/Bs is large is obtained.

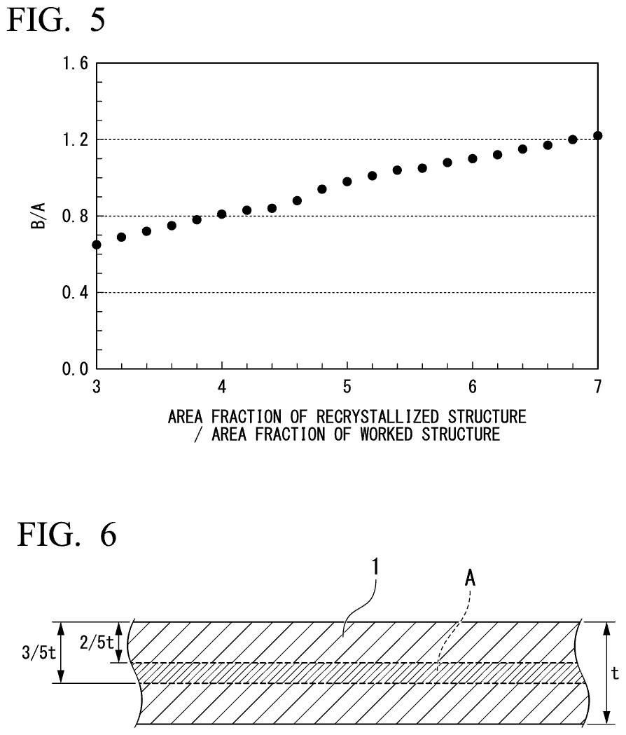

As shown in FIG. 5, when an area fraction of a recrystallized structure of a hot band before cold rolling and annealing exceeds 5 times an area fraction of a worked structure, B/A of a product sheet after cold rolling and annealing becomes less than 0.8, and ΔB50/Bs becomes significantly large. Therefore, an area proportion of a recrystallized structure to a worked structure of 5:1 is one of the criteria for a microstructure proportion of a hot band. When the area fraction of a recrystallized structure is less than 4 times the area fraction of a worked structure, B/A exceeds 1.0, and B50/Bs is significantly deteriorated. Therefore, the area proportion of 4:1 is another criterion for the microstructure proportion of a hot band.

Based on the above, the area proportion of a recrystallized structure to a worked structure is controlled to 5:1 to 4:1.

The area proportion of each microstructure is measured by the following method. First, a cross section parallel to a rolling direction and a sheet thickness direction of a hot band is confirmed by a metallographic structure photograph at a magnification of 25 times. The field of view at this time is sheet thickness×10 mm (longitudinal direction). Thereafter, marking is performed at a pitch of 100 μm along each of the sheet thickness direction and the longitudinal direction, and it is determined whether the microstructure of the marked portion is a recrystallized structure or a worked structure. By observing the metallographic structure, the recrystallized structure and the worked structure can be easily distinguished. Then, the number of portions of the recrystallized structure and the number and proportion of portions of the worked structure were measured.

When parameter PT1 exceeds 21500, recrystallization excessively proceeds, and the proportion of the recrystallized structure to the worked structure deviates from a range of 5:1 to 4:1. Therefore, parameter PT1 is preferably 21500 or less.

The coil subjected to hot rolling is then subjected to a pickling step, and cold rolling is performed. At this time, cold rolling may be performed twice in which annealing is performed. The sheet thickness of the final product is preferably 0.20 to 0.50 mm from the viewpoint of magnetic characteristics, and more preferably in a range of 0.25 to 0.50 mm in consideration of productivity. At this time, the final cold rolling ratio is preferably 75 to 90% from the viewpoint of magnetic characteristics, and more preferably 80 to 88% in consideration of both magnetic characteristics and productivity.

The steel sheet after the cold rolling is subjected to finish annealing. Heating conditions in the annealing step is not particularly limited. The soaking temperature during the finish annealing is preferably 950 to 1100° C., and more preferably in a range of 1000 to 1100° C., from the viewpoint of magnetic characteristics. The soaking temperature in the finish annealing is a surface temperature of the steel sheet after the cold rolling. The annealing time is preferably 10 to 180 seconds as the soaking time, and more preferably 15 to 60 seconds in consideration of magnetic characteristics and productivity.

In order to obtain the non-oriented electrical steel sheet according to the present embodiment, in addition to the above steps, an insulating coating forming step of forming an insulating coating on a surface of the steel sheet after the finish annealing step may be provided as in a manufacturing step of a conventional non-oriented electrical steel sheet. As the conditions of the insulating coating forming step, the same conditions as those for an insulating coating forming step of a conventional non-oriented electrical steel sheet may be adopted.

### EXAMPLES

Next, Examples of the present invention will be described, but conditions in Examples are examples of conditions adopted to confirm feasibility and an effect of the present invention, and the present invention is not limited to these examples of conditions. The present invention can adopt various conditions as long as the object of the present invention is achieved without departing from the gist of the present invention.

### Example 1

After casting a slab with the composition adjusted, a silicon steel sheet was manufactured by controlling manufacturing conditions in each step to obtain a silicon steel sheet having the chemical composition shown in Table 1.

Hot rolling and post-coiling soaking treatment were performed under the manufacturing conditions shown in Tables 2A and 2B, and after cooling to room temperature, pickling was performed. “Soaking after coiling” in the table indicates heat retention during cooling after hot rolling and coiling, and means keeping in a temperature range of +10° C. Thereafter, the steel sheet was cold rolled to a sheet thickness of 0.25 to 0.35 mm by cold rolling. In addition, in final annealing, the soaking temperature was 950° C. or higher and the soaking time was 60 seconds or longer in order to reliably recrystallize. In Tables 2A and 2B, inappropriate values were underlined.

TABLE 1

| Steel | Chemical composition (mass %) | | | | | | | | | | | |
|---|---|---|---|---|---|---|---|---|---|---|---|---|
| No. | C | Si | Mn | P | S | Al | N | Ti | B | Sn | Sb | Sn + 2Sb |
| A1 | 0.0005 | 2.1 | 0.2 | 0.150 | 0.0008 | 0.13 | 0.0008 | 0.0008 | 0.0011 | 0.02 | 0.005 | 0.03 |
| A2 | 0.0030 | 2.2 | 0.4 | 0.120 | 0.0009 | 0.15 | 0.0005 | 0.0011 | 0.0013 | 0.01 | 0.010 | 0.03 |
| A3 | 0.0008 | 1.5 | 0.5 | 0.150 | 0.0007 | 0.18 | 0.0009 | 0.0013 | 0.0015 | 0.02 | 0.045 | 0.11 |
| A4 | 0.0010 | 3.5 | 0.6 | 0.090 | 0.0008 | 0.56 | 0.0008 | 0.0012 | 0.0012 | 0.05 | 0.060 | 0.17 |
| A5 | 0.0013 | 1.8 | 0.1 | 0.080 | 0.0011 | 0.55 | 0.0009 | 0.0022 | 0.0012 | 0.04 | 0.025 | 0.09 |
| A6 | 0.0015 | 1.9 | 2.0 | 0.110 | 0.0015 | 0.58 | 0.0011 | 0.0013 | 0.0012 | 0.05 | 0.015 | 0.08 |
| A7 | 0.0018 | 2.1 | 1.5 | 0.180 | 0.0012 | 0.61 | 0.0015 | 0.0023 | 0.0015 | 0.02 | 0.035 | 0.09 |
| A8 | 0.0019 | 1.9 | 1.2 | 0.090 | 0.0005 | 0.79 | 0.0014 | 0.0009 | 0.0014 | 0.01 | 0.010 | 0.03 |
| A9 | 0.0009 | 1.6 | 1.5 | 0.030 | 0.0030 | 0.71 | 0.0021 | 0.0012 | 0.0012 | 0.01 | 0.020 | 0.05 |
| A10 | 0.0011 | 1.9 | 1.4 | 0.060 | 0.0014 | 0.10 | 0.0018 | 0.0013 | 0.0014 | 0.03 | 0.015 | 0.06 |
| A11 | 0.0018 | 3.2 | 1.8 | 0.160 | 0.0018 | 2.00 | 0.0012 | 0.0012 | 0.0013 | 0.04 | 0.005 | 0.05 |
| A12 | 0.0021 | 3.1 | 1.6 | 0.150 | 0.0015 | 0.92 | 0.0005 | 0.0009 | 0.0015 | 0.03 | 0.020 | 0.07 |
| A13 | 0.0022 | 3.0 | 1.7 | 0.110 | 0.0016 | 1.13 | 0.0030 | 0.0011 | 0.0008 | 0.06 | 0.015 | 0.09 |
| A14 | 0.0025 | 3.3 | 1.6 | 0.120 | 0.0022 | 1.21 | 0.0011 | 0.0005 | 0.0009 | 0.07 | 0.020 | 0.11 |
| A15 | 0.0021 | 3.2 | 1.8 | 0.090 | 0.0021 | 1.18 | 0.0016 | 0.0030 | 0.0007 | 0.08 | 0.030 | 0.14 |
| A16 | 0.0016 | 2.8 | 1.5 | 0.080 | 0.0018 | 0.91 | 0.0021 | 0.0019 | 0.0020 | 0.09 | 0.035 | 0.16 |
| A17 | 0.0018 | 2.9 | 1.6 | 0.110 | 0.0015 | 0.47 | 0.0011 | 0.0012 | 0.0012 | 0.01 | 0.005 | 0.02 |
| A18 | 0.0009 | 2.9 | 1.9 | 0.070 | 0.0012 | 0.32 | 0.0012 | 0.0015 | 0.0012 | 0.10 | 0.050 | 0.20 |
| A19 | 0.0008 | 2.7 | 0.2 | 0.045 | 0.0008 | 0.67 | 0.0015 | 0.0012 | 0.0014 | 0.03 | 0.055 | 0.14 |
| A20 | 0.0017 | 3.2 | 1.8 | 0.160 | 0.0009 | 0.66 | 0.0011 | 0.0014 | 0.0014 | 0.06 | 0.040 | 0.14 |
| A21 | 0.0008 | 2.7 | 0.2 | 0.045 | 0.0008 | 0.67 | 0.0015 | 0.0012 | 0.0014 | 0.03 | 0.055 | 0.01 |
| A22 | 0.0017 | 3.2 | 1.8 | 0.160 | 0.0009 | 0.66 | 0.0011 | 0.0014 | 0.0014 | 0.06 | 0.040 | 0.23 |
| a1 | 0.0001 | 1.8 | 0.5 | 0.130 | 0.0007 | 0.23 | 0.0015 | 0.0011 | 0.0012 | 0.09 | 0.030 | 0.15 |
| a2 | 0.0031 | 1.9 | 0.7 | 0.110 | 0.0015 | 0.25 | 0.0022 | 0.0014 | 0.0014 | 0.07 | 0.025 | 0.12 |
| a3 | 0.0011 | 1.1 | 0.9 | 0.150 | 0.0022 | 0.24 | 0.0015 | 0.0012 | 0.0014 | 0.04 | 0.050 | 0.14 |
| a4 | 0.0015 | 4.2 | 1.2 | 0.050 | 0.0015 | 0.88 | 0.0018 | 0.0018 | 0.0008 | 0.08 | 0.030 | 0.14 |
| a5 | 0.0018 | 2.3 | 0.04 | 0.070 | 0.0008 | 0.92 | 0.0021 | 0.0014 | 0.0012 | 0.04 | 0.005 | 0.05 |
| a6 | 0.0019 | 2.6 | 2.3 | 0.120 | 0.0009 | 0.98 | 0.0018 | 0.0011 | 0.0014 | 0.01 | 0.005 | 0.02 |
| a7 | 0.0012 | 3.2 | 1.5 | 0.210 | 0.0011 | 1.22 | 0.0014 | 0.0021 | 0.0015 | 0.03 | 0.020 | 0.07 |
| a8 | 0.0018 | 3.4 | 1.8 | 0.160 | 0.0004 | 1.32 | 0.0015 | 0.0012 | 0.0013 | 0.02 | 0.005 | 0.03 |
| a9 | 0.0022 | 1.8 | 1.5 | 0.120 | 0.0031 | 0.98 | 0.0008 | 0.0015 | 0.0014 | 0.04 | 0.010 | 0.06 |
| a10 | 0.0019 | 2.5 | 1.9 | 0.110 | 0.0014 | 0.05 | 0.0014 | 0.0018 | 0.0012 | 0.02 | 0.005 | 0.03 |
| a11 | 0.0018 | 2.8 | 1.5 | 0.120 | 0.0021 | 2.10 | 0.0021 | 0.0021 | 0.0018 | 0.01 | 0.020 | 0.05 |
| a12 | 0.0012 | 1.6 | 1.9 | 0.110 | 0.0012 | 1.01 | 0.0004 | 0.0021 | 0.0015 | 0.02 | 0.015 | 0.05 |
| a13 | 0.0009 | 3.1 | 1.8 | 0.110 | 0.0008 | 1.05 | 0.0034 | 0.0016 | 0.0014 | 0.02 | 0.020 | 0.06 |
| a14 | 0.0007 | 3.3 | 0.9 | 0.110 | 0.0009 | 1.18 | 0.0011 | 0.0003 | 0.0013 | 0.02 | 0.005 | 0.03 |
| a15 | 0.0008 | 2.9 | 1.5 | 0.050 | 0.0012 | 0.91 | 0.0015 | 0.0032 | 0.0018 | 0.01 | 0.015 | 0.04 |
| a16 | 0.0009 | 2.8 | 0.3 | 0.070 | 0.0013 | 0.85 | 0.0021 | 0.0013 | 0.0030 | 0.05 | 0.015 | 0.08 |
| A23 | 0.0030 | 3.33 | 1.01 | 0.01 | 0.0005 | 0.74 | 0.0019 | 0.0012 | — | 0.05 | — | 0.05 |

TABLE 2A

| | | | | | | Finish | |
|---|---|---|---|---|---|---|---|
| | | After | Before finish rolling | | | rolling | Coiling |
| | Slab | rough | Surface | Central layer | Temperature | Finishing | Coiling |
| Manufacturing | heating | rolling | temperature | temperature | difference ΔT | temperature | temperature |
| method | temperature | Cooling | TS | TC | (TC − TS) | FT | CT |
| No. | (° C.) | method | (° C.) | (° C.) | (° C.) | (° C.) | (° C.) |
| B1 | 1090 | Waiting | 920 | 1000 | 80 | 890 | 730 |
| B2 | 1150 | Waiting | 920 | 1010 | 90 | 910 | 740 |
| B3 | 1130 | Waiting | 930 | 1010 | 80 | 920 | 720 |
| B4 | 1120 | Air | 940 | 1020 | 80 | 880 | 740 |
| B5 | 1090 | Air | 930 | 1020 | 90 | 890 | 750 |
| b1 | 1130 | Waiting | 930 | 1010 | 80 | 720 | 640 |
| b2 | 1100 | Waiting | 910 | 1000 | 90 | 1020 | 940 |
| b3 | 1180 | Air | 920 | 1020 | 100 | 1050 | 950 |
| b4 | 1160 | Waiting | 930 | 970 | 40 | 890 | 730 |
| b5 | 1160 | Waiting | 910 | 1000 | 90 | 890 | 900 |
| b6 | 1160 | Air | 920 | 1020 | 100 | 910 | 740 |
| b7 | 1160 | Waiting | 930 | 990 | 60 | 770 | 650 |
| b8 | 1160 | Waiting | 910 | 1100 | 100 | 820 | 640 |
| b9 | 1160 | Air | 920 | 1100 | 180 | 820 | 790 |

TABLE 2B

| | Soaking after coiling | | | | | Hot- | | Cold- | | |
|---|---|---|---|---|---|---|---|---|---|---|
| | After 10 minutes | | | | | rolled | Cold | rolled | | |
| | of coiling | | | | | steel | rolling | steel | Finish | |
| | Temperature at | | Soaking | Average | | sheet | Cold- | sheet | annealing | |
| Manufacturing | center portion of | | time | temperature | | Sheet | rolling | Sheet | Soaking | Soaking |
| method | sheet width TWC | Parameter | HA | TA | Parameter | thickness | reduction | thickness | temperature | time |
| No. | (° C.) | PT1 | (min) | (° C.) | PT2 | (mm) | (%) | (mm) | (° C.) | (sec) |
| B1 | 730 | 19280 | 160 | 720 | 20283 | 1.9 | 87 | 0.25 | 1000 | 60 |
| B2 | 740 | 19472 | 78 | 730 | 20174 | 2.5 | 88 | 0.30 | 1020 | 120 |
| B3 | 715 | 19039 | 170 | 710 | 20105 | 2.3 | 85 | 0.35 | 1050 | 90 |
| B4 | 730 | 19376 | 90 | 720 | 20035 | 2.5 | 86 | 0.35 | 1090 | 80 |
| B5 | 745 | 19616 | 60 | 740 | 20260 | 1.9 | 84 | 0.30 | 1020 | 100 |
| b1 | 540 | 16588 | 100 | 760 | 20889 | 2.3 | 85 | 0.35 | 990 | 110 |
| b2 | 800 | 21971 | 40 | 790 | 21073 | 2.3 | 85 | 0.35 | 980 | 80 |
| b3 | 800 | 22067 | 60 | 820 | 21860 | 2.2 | 89 | 0.25 | 970 | 90 |
| b4 | 730 | 19280 | 160 | 720 | 20283 | 1.9 | 87 | 0.25 | 1000 | 60 |
| b5 | 800 | 21586 | 78 | 730 | 20174 | 2.5 | 88 | 0.3 | 1020 | 120 |
| b6 | 740 | 19472 | 80 | 710 | 19783 | 2.3 | 85 | 0.35 | 1050 | 90 |
| b7 | 660 | 17838 | 160 | 720 | 20283 | 1.9 | 87 | 0.25 | 1000 | 60 |
| b8 | 700 | 18126 | 78 | 730 | 20174 | 2.5 | 88 | 0.30 | 1020 | 120 |
| b9 | 540 | 18030 | 160 | 710 | 20079 | 2.3 | 85 | 0.35 | 1050 | 90 |

The texture of each manufacturing condition is shown in Table 3A, and the magnetic flux density B50, the magnetic flux density deviation ΔB50 for each angle, the saturation magnetic flux density Bs, and the proportion of the magnetic flux density to the saturation magnetic flux density are shown in Table 3B. In Table 3A, inappropriate values were underlined. Test No. c26 disclosed in Tables 3A and 3B is an inventive example of Test No. 3 disclosed in Table 2 of Patent Document 3. Test No. c26 is obtained under the manufacturing conditions including hot-band annealing disclosed in Patent Document 3. Therefore, in Tables 3A and 3B, the description of the manufacturing condition number of Test No. c26 was omitted.

The magnetic flux density of the electrical steel sheet was measured in the rolling direction and the sheet width direction when the steel sheet was magnetized with a magnetization force of 5000 A/m by a single sheet tester (SST). In addition, in the 45° direction, the SST sample was sheared in a direction of 45° with respect to the rolling direction, and an average value in two directions was taken. The magnetic flux density B50 was determined by measuring the magnetic flux density in unit: T (tesla) as described above. In addition, the magnetization force was gradually increased, the magnetic flux density when the magnetic flux density was saturated was measured in unit: T (tesla), and the saturation magnetic flux density Bs was measured.

TABLE 3A

| | | Manu- | Texture strength | | |
|---|---|---|---|---|---|
| | | facturing | {111}<112> | {100}<012> | Strength |
| Reference | Steel | method | Orientation | Orientation | proportion |
| symbol | No. | No. | strength A | strength B | B/A |
| C1 | A1 | B1 | 5 | 4 | 0.8 |
| C2 | A2 | B2 | 6 | 5 | 0.8 |
| C3 | A3 | B3 | 4 | 3 | 0.8 |
| C4 | A4 | B4 | 7 | 6 | 0.9 |
| C5 | A5 | B5 | 8 | 7 | 0.9 |
| C6 | A6 | B1 | 8 | 8 | 1.0 |
| C7 | A7 | B2 | 4 | 3 | 0.8 |
| C8 | A8 | B3 | 5 | 4 | 0.8 |
| C9 | A9 | B4 | 7 | 6 | 0.9 |
| C10 | A10 | B5 | 3 | 3 | 1.0 |
| C11 | A11 | B1 | 6 | 6 | 1.0 |
| C12 | A12 | B2 | 8 | 7 | 0.9 |
| C13 | A13 | B3 | 3 | 3 | 1.0 |
| C14 | A14 | B4 | 6 | 5 | 0.8 |
| C15 | A15 | B5 | 8 | 6 | 0.8 |
| C16 | A16 | B1 | 2 | 2 | 1.0 |
| C17 | A17 | B2 | 5 | 4 | 0.8 |
| C18 | A18 | B3 | 6 | 6 | 1.0 |
| C19 | A19 | B4 | 3 | 3 | 1.0 |
| C20 | A20 | B5 | 6 | 5 | 0.8 |
| C21 | A21 | B4 | 4 | 3 | 0.8 |
| C22 | A22 | B5 | 5 | 5 | 1.0 |
| c1 | a1 | b1 | 1 | 0.2 | 0.2 |
| c2 | a2 | b2 | 1 | 0.3 | 0.3 |
| c3 | a3 | b3 | 1 | 0.4 | 0.4 |
| c4 | a4 | b1 | 1 | 1.1 | 1.1 |
| c5 | a5 | b2 | 1 | 1.2 | 1.2 |
| c6 | a6 | b3 | 11 | 13.2 | 1.2 |
| c7 | a7 | b1 | 13 | 16.9 | 1.3 |
| c8 | a8 | b2 | 12 | 16.8 | 1.4 |
| c9 | a9 | b3 | 14 | 21 | 1.5 |
| c10 | a10 | b1 | 15 | 21 | 1.4 |
| c11 | a11 | b2 | 14 | 19.6 | 1.4 |
| c12 | a12 | b3 | 15 | 21 | 1.4 |
| c13 | a13 | b1 | 15 | 22.5 | 1.5 |
| c14 | a14 | b2 | 12 | 14.4 | 1.2 |
| c15 | a15 | b3 | 13 | 19.5 | 1.5 |
| c16 | a16 | b1 | 12 | 14.4 | 1.2 |
| c17 | A1 | b1 | 1 | 0.5 | 0.5 |
| c18 | A2 | b2 | 1 | 0.6 | 0.6 |
| c19 | A3 | b3 | 1 | 0.5 | 0.5 |
| c20 | A1 | b4 | 1 | 1.0 | 0.8 |
| c21 | A2 | b5 | 11 | 10 | 0.9 |
| c22 | A3 | b6 | 2 | 1.0 | 0.5 |
| c23 | A4 | b7 | 1 | 1.2 | 0.9 |
| c24 | A5 | b8 | 12 | 10 | 0.8 |
| c25 | A6 | b9 | 2 | 1.0 | 0.5 |
| c26 | A23 | — | 11 | 6 | 0.5 |

TABLE 3B

| | Magnetic flux density | | | | | | |
|---|---|---|---|---|---|---|---|
| | | | Direction | Difference between | | | |
| | | Orthogonal- | 45 degrees | absolute maximum | Saturation | Proportion | |
| | Rolling | to-rolling | from rolling | value and absolute | magnetic | to saturation | |
| Reference | direction | direction | direction | minimum value | flux density | magnetic flux density | |
| symbol | B50-L | B50-C | B50-45 | ΔB50 | Bs | B50/Bs | ΔB50/Bs |
| C1 | 1.77 | 1.73 | 1.69 | 0.08 | 2.06 | 0.85 | 0.04 |
| C2 | 1.76 | 1.73 | 1.68 | 0.08 | 2.05 | 0.85 | 0.04 |
| C3 | 1.78 | 1.71 | 1.70 | 0.08 | 2.07 | 0.84 | 0.04 |
| C4 | 1.69 | 1.62 | 1.62 | 0.07 | 1.97 | 0.84 | 0.04 |
| C5 | 1.76 | 1.72 | 1.69 | 0.07 | 2.05 | 0.85 | 0.03 |
| C6 | 1.72 | 1.64 | 1.63 | 0.09 | 2.00 | 0.84 | 0.04 |
| C7 | 1.72 | 1.65 | 1.65 | 0.07 | 2.00 | 0.84 | 0.03 |
| C8 | 1.72 | 1.66 | 1.65 | 0.07 | 2.01 | 0.84 | 0.03 |
| C9 | 1.73 | 1.65 | 1.65 | 0.08 | 2.02 | 0.84 | 0.04 |
| C10 | 1.76 | 1.69 | 1.68 | 0.08 | 2.04 | 0.84 | 0.04 |
| C11 | 1.60 | 1.52 | 1.52 | 0.08 | 1.87 | 0.84 | 0.04 |
| C12 | 1.67 | 1.61 | 1.60 | 0.07 | 1.94 | 0.84 | 0.04 |
| C13 | 1.66 | 1.59 | 1.57 | 0.09 | 1.93 | 0.84 | 0.05 |
| C14 | 1.65 | 1.59 | 1.58 | 0.07 | 1.92 | 0.84 | 0.04 |
| C15 | 1.65 | 1.58 | 1.57 | 0.08 | 1.92 | 0.84 | 0.04 |
| C16 | 1.68 | 1.62 | 1.61 | 0.07 | 1.96 | 0.84 | 0.04 |
| C17 | 1.70 | 1.63 | 1.62 | 0.08 | 1.98 | 0.84 | 0.04 |
| C18 | 1.70 | 1.66 | 1.60 | 0.10 | 1.98 | 0.85 | 0.05 |
| C19 | 1.72 | 1.65 | 1.64 | 0.08 | 2.00 | 0.84 | 0.04 |
| C20 | 1.67 | 1.61 | 1.59 | 0.08 | 1.95 | 0.84 | 0.04 |
| C21 | 1.72 | 1.66 | 1.63 | 0.09 | 2.00 | 0.84 | 0.04 |
| C22 | 1.67 | 1.60 | 1.58 | 0.09 | 1.95 | 0.84 | 0.05 |
| c1 | 1.77 | 1.66 | 1.65 | 0.12 | 2.06 | 0.83 | 0.06 |
| c2 | 1.76 | 1.63 | 1.64 | 0.12 | 2.05 | 0.83 | 0.06 |
| c3 | 1.79 | 1.66 | 1.67 | 0.12 | 2.08 | 0.83 | 0.06 |
| c4 | 1.64 | 1.58 | 1.49 | 0.15 | 1.91 | 0.84 | 0.08 |
| c5 | 1.72 | 1.68 | 1.59 | 0.13 | 2.00 | 0.85 | 0.06 |
| c6 | 1.67 | 1.61 | 1.52 | 0.15 | 1.94 | 0.84 | 0.08 |
| c7 | 1.65 | 1.58 | 1.49 | 0.16 | 1.92 | 0.84 | 0.08 |
| c8 | 1.63 | 1.60 | 1.49 | 0.14 | 1.90 | 0.85 | 0.07 |
| c9 | 1.71 | 1.65 | 1.55 | 0.16 | 1.99 | 0.84 | 0.08 |
| c10 | 1.73 | 1.69 | 1.58 | 0.15 | 2.01 | 0.85 | 0.07 |
| c11 | 1.62 | 1.58 | 1.47 | 0.15 | 1.88 | 0.85 | 0.08 |
| c12 | 1.71 | 1.68 | 1.57 | 0.14 | 1.99 | 0.85 | 0.07 |
| c13 | 1.66 | 1.64 | 1.51 | 0.15 | 1.93 | 0.85 | 0.08 |
| c14 | 1.66 | 1.60 | 1.53 | 0.13 | 1.93 | 0.84 | 0.07 |
| c15 | 1.68 | 1.65 | 1.53 | 0.15 | 1.95 | 0.85 | 0.08 |
| c16 | 1.70 | 1.65 | 1.55 | 0.15 | 1.98 | 0.85 | 0.08 |
| c17 | 1.77 | 1.73 | 1.64 | 0.13 | 2.06 | 0.85 | 0.06 |
| c18 | 1.76 | 1.73 | 1.64 | 0.12 | 2.05 | 0.85 | 0.06 |
| c19 | 1.78 | 1.71 | 1.65 | 0.13 | 2.07 | 0.84 | 0.06 |
| c20 | 1.77 | 1.73 | 1.65 | 0.12 | 2.06 | 0.85 | 0.06 |
| c21 | 1.76 | 1.73 | 1.64 | 0.12 | 2.05 | 0.85 | 0.06 |
| c22 | 1.78 | 1.71 | 1.66 | 0.12 | 2.07 | 0.84 | 0.06 |
| c23 | 1.69 | 1.62 | 1.57 | 0.12 | 1.97 | 0.84 | 0.06 |
| c24 | 1.76 | 1.72 | 1.64 | 0.12 | 2.05 | 0.85 | 0.06 |
| c25 | 1.72 | 1.64 | 1.60 | 0.12 | 2.00 | 0.84 | 0.06 |
| c26 | 1.71 | 1.65 | 1.57 | 0.11 | 1.95 | 0.86 | 0.06 |

In the inventive examples of Test Nos. C1 to C20, the composition, the manufacturing method, and the texture were preferably controlled for the silicon steel sheet, and Formulas (1) to (3) were satisfied, and thus ΔB50, B50/Bs, and ΔB50/Bs were excellent as the non-oriented electrical steel sheet. In addition, these inventive examples were excellent in magnetic characteristics despite being obtained by a manufacturing method not including hot-band annealing. Therefore, the inventive examples were also excellent in productivity.

The above ΔB50 is preferably 0.10 or less, more preferably 0.09 or less, and still more preferably 0.07 or less. In addition, B50/Bs is preferably 0.84 or more, more preferably 0.85 or more, and still more preferably 0.86 or more. In addition, ΔB50/Bs is 0.05 or less, preferably 0.04 or less, and more preferably 0.03 or less. In Table 4, B50/Bs and ΔB50/Bs not within the above preferred ranges were underlined.

In the comparative examples of Test Nos. c1 to c19, at least one of the composition, the manufacturing method, and the texture is not preferably controlled for the silicon steel sheet, and Formulas (1) to (3) are not satisfied, and thus one or both of B50/Bs and ΔB50/Bs are not satisfied as the non-oriented electrical steel sheet.

In the comparative example of Test No. c20, the strength of the {111}<112> orientation, a crystal orientation measured at a position in a range of 2/5 t to 3/5 t, (orientation strength A) was inappropriate. This is presumed to be because the difference (ΔT) between the temperature TS of the sheet surface and the temperature of the steel sheet central layer TC before finish rolling was inappropriate under manufacturing condition b4 applied to Test No. c20. Test No. c20 failed in ΔB50/Bs.

In the comparative example of Test No. c21, an orientation strength A (that is, the strength of the {111}<112> orientation, a crystal orientation measured at a position in a range of 2/5 t to 3/5 t) was inappropriate. This is presumed to be because parameter PT1 was inappropriate under manufacturing condition b5 applied to Test No. c21. Test No. c21 failed in ΔB50/Bs.

In the comparative example of Test No. c22, proportion B/A of orientation strength B (that is, the strength of the {100}<012> orientation measured at the position in a range of 2/5 t to 3/5 t) to orientation strength A was inappropriate. This is presumed to be because parameter PT2 was inappropriate under manufacturing condition b6 applied to Test No. c22. Test No. c22 failed in ΔB50/Bs.

In the comparative example of Test No. c23, orientation strength A was inappropriate. This is presumed to be because the finish rolling finishing temperature FT (that is, the steel sheet surface temperature during passing through a final stand of finish rolling in hot rolling) was inappropriate under manufacturing condition b7 applied to Test No. c23. Test No. c23 failed in ΔB50/Bs.

In the comparative example of Test No. c24, orientation strength A was inappropriate. This is presumed to be because the coiling temperature CT (that is, the steel sheet surface temperature during coiling in hot rolling) was inappropriate under manufacturing condition b8 applied to Test No. c24. Test No. c24 failed in ΔB50/Bs.

In the comparative example of Test No. c25, proportion B/A of orientation strength B to orientation strength A was inappropriate. This is presumed to be because the temperature at the center portion of the sheet width TWC (that is, the steel sheet surface temperature at the center portion in the width direction of the coiled hot band at the time point at which 10 minutes elapsed from completion of coiling) was inappropriate under manufacturing condition b9 applied to Test No. c25. Test No. c25 failed in ΔB50/Bs.

The comparative example of Test No. c26 is an inventive example of Test No. 3 disclosed in Table 2 of Patent Document 3. In the comparative example of Test No. c26, orientation strength A and proportion B/A of orientation strength B to orientation strength A were inappropriate. Test No. c26 failed in ΔB50/Bs.

The reason why orientation strength A and proportion B/A of orientation strength B to orientation strength A were inappropriate in Test No. c26 is presumed to be the manufacturing conditions. In the manufacturing method of the comparative example of Test No. c26, hot-band annealing of soaking at 1000° C. for 1 minute was performed, but no special control was performed on the hot rolling conditions and the coiling conditions.

### BRIEF DESCRIPTION OF THE REFERENCE SYMBOLS

1 Non-oriented electrical steel sheet
t Sheet thickness of non-oriented electrical steel sheet
A Position in range of 2/5 t to 3/5 t (thickness middle portion)
2 Coil
C Center portion in width direction of coiled hot band

1. A non-oriented electrical steel sheet comprising, as a chemical composition, in mass %:
C: 0.0005 to 0.0030%,
Si: 1.5 to 3.5%,
Al: 0.10 to 2.00%,
Mn: 0.1 to 2.0%,
P: 0.180% or less,
S: 0.0005 to 0.0030%,
N: 0.0005 to 0.0030%,
Ti: 0.0005 to 0.0030%,
B: 0 to 0.0020%, and
Sn+2×Sb: 0 to 0.25%; and
the remainder being Fe and impurities,
wherein the following Formulas (1) to (3) are satisfied, in which a sheet thickness is t, a strength of a {111}<112> orientation, a crystal orientation measured at a position in a range of 2/5 t to 3/5 t is A, and a strength of a {100}<012> orientation measured at the position in a range of 2/5 t to 3/5 t is B,
$$2 \leq A \leq 10 , \qquad Formula ( 1 )$$
$$1. \leq B \leq 10 , and \qquad Formula ( 2 )$$
$$0.8 \leq B / A \leq 1. . \qquad Formula ( 3 )$$

2. The non-oriented electrical steel sheet according to claim 1, wherein the composition contains, in mass %, Sn or Sb in a range of 0.02≤Sn+2×Sb≤0.20.

3. A non-oriented electrical steel sheet comprising, as a chemical composition, in mass %:
C: 0.0005 to 0.0030%,
Si: 1.5 to 3.5%,
Al: 0.10 to 2.00%,
Mn: 0.1 to 2.0%,
P: 0.180% or less,
S: 0.0005 to 0.0030%,
N: 0.0005 to 0.0030%,
Ti: 0.0005 to 0.0030%,
B: 0 to 0.0020%, and
Sn+2×Sb: 0 to 0.25%; and
the remainder comprising Fe and impurities,
wherein the following Formulas (1) to (3) are satisfied, in which a sheet thickness is t, a strength of a {111}<112> orientation, a crystal orientation measured at a position in a range of 2/5 t to 3/5 t is A, and a strength of a {100}<012> orientation measured at the position in a range of 2/5 t to 3/5 t is B,
$$2 \leq A \leq 10 , \qquad Formula ( 1 )$$
$$1. \leq B \leq 10 , and \qquad Formula ( 2 )$$
$$0.8 \leq B / A \leq 1. . \qquad Formula ( 3 )$$
